(19) United States
(12) Patent Application Publication
(10) Pub. No.: US 2008/0048576 A1
(43) Pub. Date: Feb. 28, 2008

(54) Method and apparatus for dimming hot cathode fluorescent lamp

(75) Inventors: Chin-Wen Chou, Taipei Hsien (TW); Ying-Nan Cheng, Taipei Hsien (TW)

Correspondence Address: BIRCH STEWART KOLASCH & BIRCH, PO BOX 747, FALLS CHURCH, VA, 22040-0747, US

(73) Assignee: ZIPPY TECHNOLOGY CORP.

(21) Appl. No.: 11/510,783

(22) Filed: Aug. 28, 2006

(51) Int. Cl. F02P 3/12

(52) U.S. Cl. 315/209 PZ

(57) ABSTRACT

The present invention discloses a method and an apparatus for dimming a hot cathode fluorescent lamp (HCFL) that combines frequency conversion and pulse width modulation (PWM) to change the outputted voltage and current of a piezoelectric transformer, so as to achieve the purpose of adjusting the brightness of a cathode fluorescent lamp. The invention can substitute a starter and a voltage regulator of a hot cathode fluorescent lamp without the need of installing a ballast that produces high heat during its operation easily, and extend the life expectancy of the fluorescent lamp, reduces the number components of the fluorescent lamp, and provides a quick start of the lamp.

### FIELD OF THE INVENTION

The present invention relates to a method and an apparatus for dimming a hot cathode fluorescent lamp, and more particularly to a method and an apparatus for changing an output voltage and power supply to adjust the brightness of a hot cathode fluorescent lamp.

### BACKGROUND OF THE INVENTION

In the installation configuration of a common fluorescent lamp available in the market, electrodes on both ends of the fluorescent lamp are electrically connected to a starter, a ballast and a switch. The fluorescent lamp is simply considered as a sealed gas discharge tube. The gas in the tube is mainly argon gas (and including neon or krypton) with an air pressure approximately equal to 0.3% of an atmosphere, and the tube also contains a small amount of mercury approximately equal to one-thousandth of the gas.

By the accelerated electrons of sufficient electric field in the fluorescent lamp, the gas in the lamp is ionized to excite the gas (the mercury atoms absorb the kinetic energy of the electrons) and radiate electromagnetic waves and emit ultraviolet rays. The fluorescent matter on the surface of the lamp absorbs the ultraviolet rays to release visible lights, and different fluorescent matters emit different visible lights.

Although the fluorescent lamp can achieve the illumination purpose, the brightness of the traditional fluorescent lamp cannot be adjusted by users based on the environment of the installed lamp, and the brightness of the lamp depends on the length of the lamp. If users want to adjust the required brightness of the illumination for the environment, then it is necessary to change a lamp of a different length, and thus causing tremendous inconvenience to users.

### SUMMARY OF THE INVENTION

The primary objective of the present invention is to overcome the foregoing shortcomings and avoid the existing deficiencies by providing a method for dimming a hot cathode fluorescent lamp that employs frequency conversion and pulse width modulation to change the outputted voltage and current of a piezoelectric transformer, so as to achieve the purpose of adjusting the brightness of the hot cathode fluorescent lamp.

The present invention uses a resonant frequency control unit to dynamically change a resonant frequency for driving a piezoelectric transformer. In other words, the dynamic frequency conversion method is changed to the voltage gain of a piezoelectric transformer for adjusting the outputted voltage and current of the piezoelectric transformer and achieving the purpose of adjusting the brightness of the hot cathode fluorescent lamp.

Another objective of the present invention is to provide a power supply control apparatus for adjusting the outputted voltage and current of a piezoelectric transformer without adversely affecting the life expectancy of the lamp.

The invention further uses a PWM control unit to integrate pulse width modulation control with dynamic frequency conversion control and also uses the frequency conversion to adjust the voltage gain of a piezoelectric transformer without changing the amplitude of vibration of the resonant frequency, so that the duty ratio can achieve the purpose of changing the outputted voltage and current of the piezoelectric transformer. The method in accordance with the present invention will not frequently charge or stop charging the piezoelectric transformer. Unlike the traditional burst mode or control method of pulse width modulation, the apparatus of the present invention further helps extending the life expectancy of the piezoelectric transformer by substituting the starter and voltage regulator of the hot cathode fluorescent lamp of present technologies, so that the hot cathode fluorescent lamp no longer needs a ballast that results in a high operating temperature. The present invention not just extends the life expectancy of the lamp and reduces the number of components, but also provides a quick start for the lamp.

### BRIEF DESCRIPTION OF THE DRAWINGS

The technical characteristics and detailed description of the present invention are illustrated by a preferred embodiment together with the attached drawings as follows.

FIG. 1 is a circuit diagram of a first preferred embodiment of the present invention;

FIG. 2 is a circuit diagram of a second preferred embodiment of the present invention;

FIG. 3 is a graph of voltage gain versus resonant frequency of a piezoelectric transformer;

FIG. 4 is a waveform diagram of a pulse width modulation control signal;

FIG. 5 is a waveform diagram of a high-frequency alternate current signal S2 of a pulse width modulation control signal as depicted in FIG. 4;

FIG. 6 is a waveform diagram of a voltage outputted at a secondary electrode of a piezoelectric transformer corresponding to a high-frequency AC signal S2 as depicted in FIG. 5;

FIG. 7 is a waveform diagram of a pulse width modulation control signal changed by dimming the brightness of a hot cathode fluorescent lamp as depicted in FIG. 4; and

FIG. 8 is a waveform diagram of a voltage outputted at a secondary electrode of a piezoelectric transformer corresponding to a pulse width modulation control signal as depicted in FIG. 7.

### DETAILED DESCRIPTION OF THE PREFERRED EMBODIMENTS

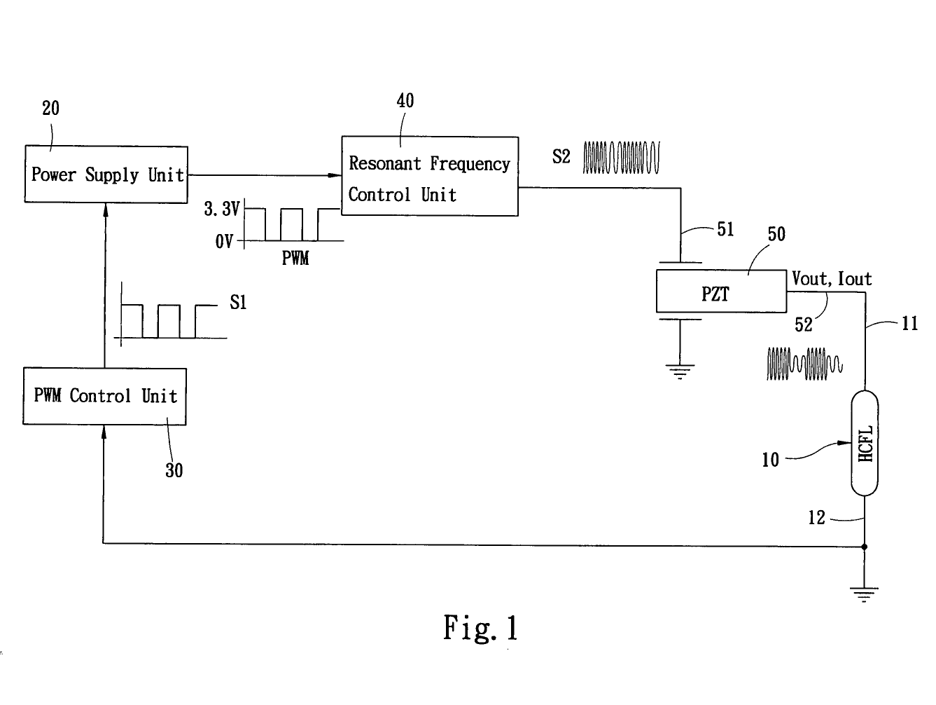

Referring to FIG. 1 for a circuit diagram of a first preferred embodiment of the present invention, the circuit is applied to an apparatus for dimming a hot cathode fluorescent lamp 10 that comprises:

a power supply unit 20, for providing a direct current power supply (depending on the specification of the hot cathode fluorescent lamp 10 and generally is a direct current power supply of zero volt to several volts) required for driving the hot cathode fluorescent lamp 10;

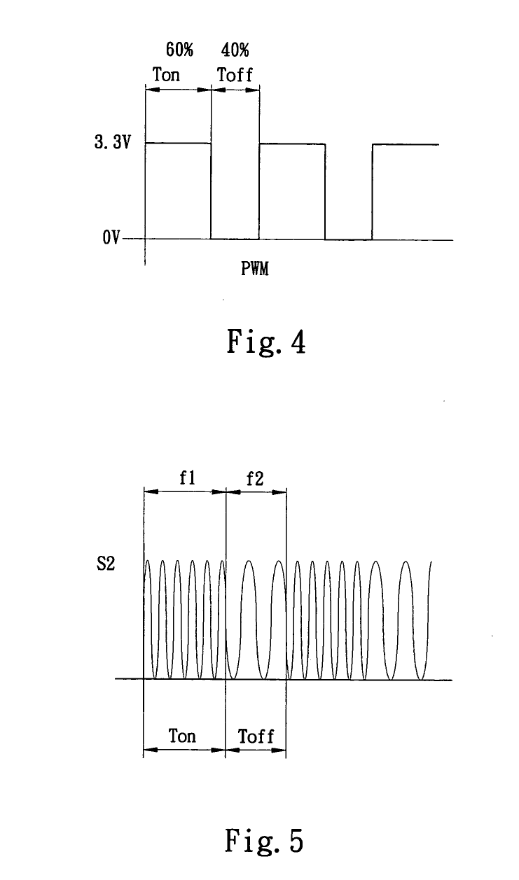

a PWM control unit 30, for outputting a pulse wave signal S1 by the pulse width modulation technology and controlling a pulse width modulation control signal by the pulse wave signal S1 in order to control the power supply unit 20 to output Ton and Toff with duty cycles. In other words, the pulse wave signal S1 is used to change the duty ratio of a direct current (DC) power supply of 0V outputted by the power supply unit 20 and a full-scale output (such as 3.3V), and their output waveforms are shown in FIG. 4;

a resonant frequency control unit 40, being a frequency controller IC, for modulating a pulse width modulation control signal outputted by the power supply unit 20 to a high-frequency alternate current signal S2, and the resonant frequency control unit 40 will produce a high-frequency alternate current signal S2 of different frequencies f1, f2 for different cycles Ton and Toff of a pulse width modulation control signal (whose output waveform is shown in FIG. 5) for changing the voltage gain of the piezoelectric transformer 50. In other words, the frequencies f1, f2 of the high-frequency alternate current signal S2 can be changed automatically in different duty cycles Ton and Toff of the pulse width modulation control signal;

a piezoelectric transformer 50, with its primary electrode 51 coupled to the high-frequency alternate current signal S2 outputted by the resonant frequency control unit 40 to increase the gain of the high-frequency alternate current signal S2 for driving the high output voltage Vout and output current Iout required by the fluorescent lamp and outputting the high output voltage Vout and output current Iout from a secondary electrode 52. The high output voltage Vout and output current Iout are electrically coupled to a high side electrode 11 of the hot cathode fluorescent lamp 10 to drive the hot cathode fluorescent lamp 10 to shine, and obtain a voltage signal from a low side electrode 12 of the hot cathode fluorescent lamp 10, so as to feed back the signals to the PWM control unit 30. By adjusting the pulse width of the pulse wave signal S1, the brightness of the hot cathode fluorescent lamp 10 can be adjusted.

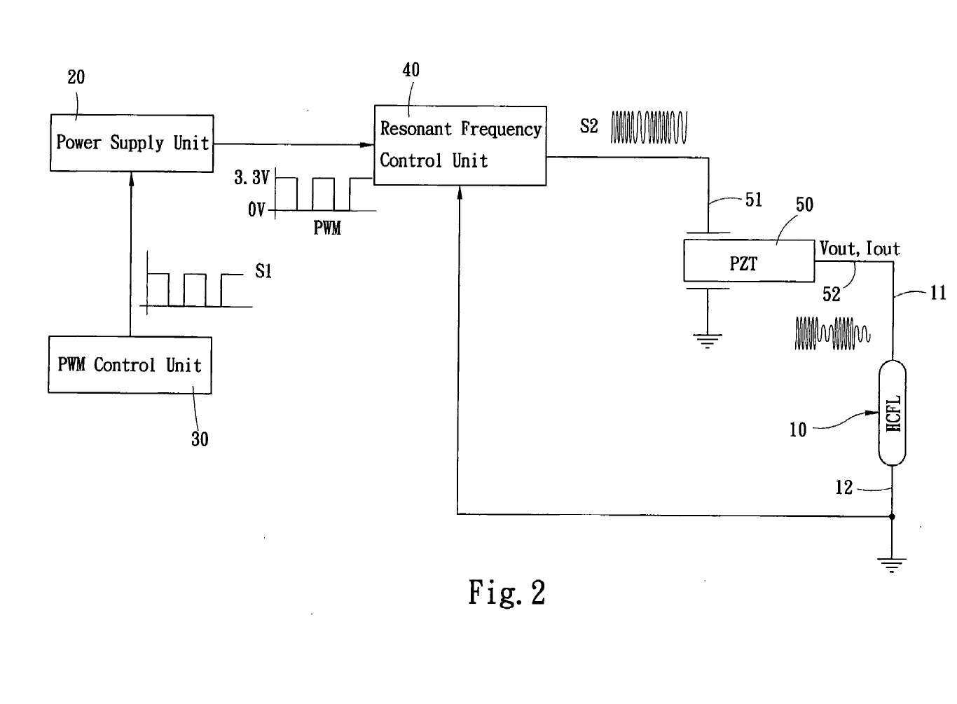

In another preferred embodiment, a voltage signal obtained from the low side electrode 12 of the hot cathode fluorescent lamp 10 is fed back to the resonant frequency control unit 40 (as shown in FIG. 2), such that the frequencies f1, f2 of the high-frequency alternate current signal S2 at different duty cycles Ton and Toff can be used to adjust the brightness of the hot cathode fluorescent lamp 10.

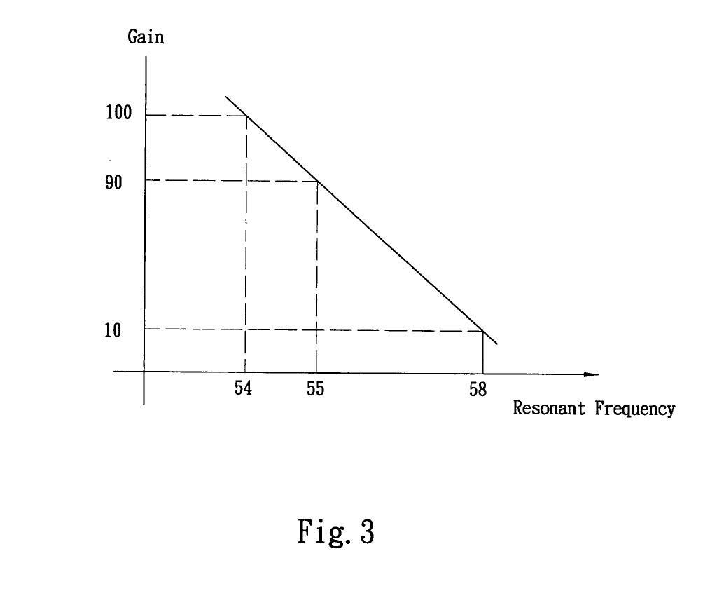

Since the voltage gain of the piezoelectric transformer 50 is related to its structure (such as a single-layer or a multi-layer structured piezoelectric transformer), and its output voltage gain can be adjusted by changing the frequency of the high-frequency alternate current signal S2 (as shown in FIG. 3). For instance, if the frequency of the high-frequency alternate current signal S2 is equal to 54 kHz and its gain is equal to 100, then the output voltage outputted at the secondary electrode 52 will be equal to 100 times of the input voltage of the primary electrode 51. In other words, the output voltage will be up to 330V, if the input voltage is equal to 3.3V.

On the other hand, after the frequency of the high-frequency alternate current signal S2 is changed to 58 kHz, the gain will drop to 10, indicating that the output voltage outputted from the secondary electrode 52 will be 10 times of the input value of the primary electrode 51. In other words, the output voltage will be up to 33V, if the input voltage is equal to 3.3V Thus, such characteristic is used for the resonant frequency control unit 40 to produce a high-frequency alternate current signal S2 of different frequencies f1, f2 at different duty cycles Ton and Toff of the pulse width modulation control signal and the high-frequency alternate current signal S2 is used to drive the operation of the piezoelectric transformer 50. By adjusting the output voltage gain of the piezoelectric transformer 50, the outputted voltage and current changes the piezoelectric transformer 50 without changing the amplitude of vibration of the pulse width modulation control signal, so as to achieve the purpose of adjusting the brightness of the hot cathode fluorescent lamp 10.

In a traditional method for controlling pulse width modulation, the duty ration for adjusting the pulse width modulation at a constant resonant frequency and the amplitude of vibration of the resonant frequency are used for controlling the current in the hot cathode fluorescent lamp, so as to achieve the purpose of adjusting the brightness of the hot cathode fluorescent lamp, and such method uses a frequency (>100 Hz) higher than a visually observable frequency to produce a duty ratio to control the average current of the hot cathode fluorescent lamp, such that the hot cathode fluorescent lamp can be operated at a total current all the time. Although this method can achieve the dimming purpose, the piezoelectric transformer is switched frequently between a fully charging state and a completely no charging state, which will adversely affect the life expectancy of the piezoelectric transformer.

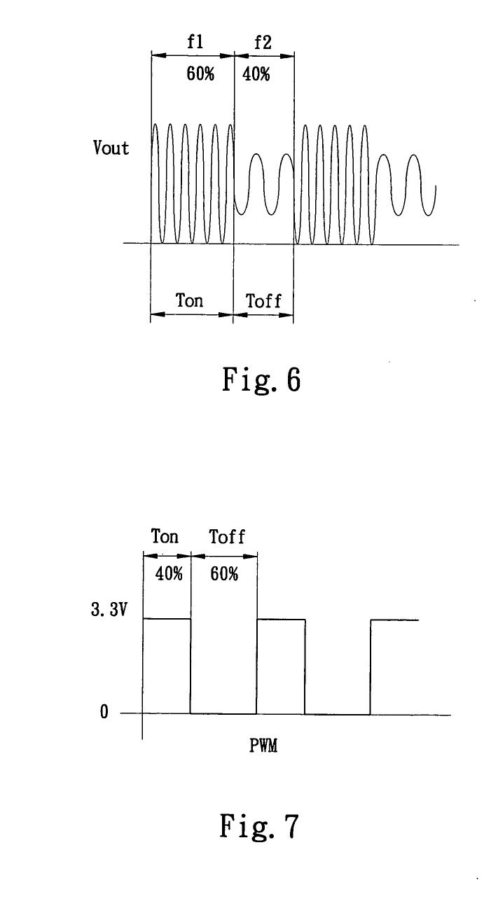

Referring to FIGS. 4 to 6 for waveform diagrams of the operation process for dimming a hot cathode fluorescent lamp 10 in accordance with the present invention, the voltage of a direct current power supply falls within a range from 0V to 3.3V. Assumed that the hot cathode fluorescent lamp 10 is operated at a certain specific brightness, the duty ratio of the pulse width modulation control signal outputted from the resonant frequency control unit 40 is equal to 60% as shown in FIG. 4, indicating that 60% of the time is ON (Ton) and 40% of the time is OFF (Toff). If the voltage of the duty cycle Ton (direct current power supply) is equal to 3.3V, then the resonant frequency control unit 40 will automatically set the frequency f1 (such as 54 kHz) to have a higher voltage gain (as shown in FIG. 5). If the gain of the piezoelectric transformer 50 is at the frequency f1, then the output voltage outputted from the secondary electrode 52 will be 100 times of the input voltage of the primary electrode 51. In other words, if the input voltage at the duty cycle Ton is equal to 3.3V, then the output voltage will be up to 330V (the operating voltage of the hot cathode fluorescent lamp is much higher than the voltage of other light sources and generally equal to 300V to 800V DC, depending on the length of the lamp), but the resonant frequency control unit 40 at the duty cycle Toff automatically changes the frequency f2 of the duty cycle Toff in the high-frequency alternate current signal S2 having a frequency (such as 58 kHz) with a lower voltage gain (as shown in FIG. 5), the voltage of the direct current power supply is equal to 0V, and the corresponding voltage outputted by the secondary electrode 52 of the piezoelectric transformer 50 will drop, and its waveform is shown in FIG. 6.

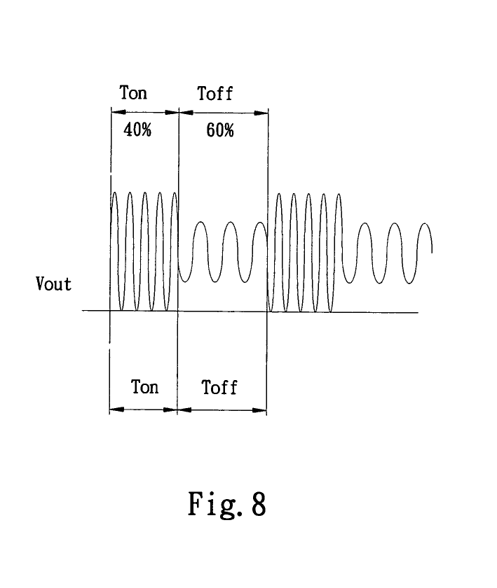

If it is necessary to dim the hot cathode fluorescent lamp 10, then the duty ratio of the pulse width modulation control signal can be changed to achieve the dimming effect. For example, the duty ratio of the pulse width modulation control signal is changed to a duty ratio 40%, indicating that 40% of the time is ON (Ton) and 60% of the time is OFF (Toff) or to other duty ratios for having the same effect. FIG. 7 shows its waveform diagram, and FIG. 8 shows the waveform diagram of the corresponding voltage outputted at the secondary electrode 52 of the piezoelectric transformer 50.

Further, the method in accordance with the present invention also can change a resonant frequency f1, f2 in different duty cycles and combine the pulse width modulation to adjust the resonant frequencies f1, f2 of the duty cycles Ton and Toff and change the gain of a piezoelectric transformer 50, so as to adjust the output voltage Vout and output current Iout and achieve the effect of adjusting (or dimming) the brightness of a hot cathode fluorescent lamp 10. In the method of the invention, a high-frequency alternate current signal S2 with a lower frequency can be achieved in the duty cycle Toff for driving the piezoelectric transformer 50, such that the charging operation of the piezoelectric transformer 50 will not affect the life expectancy of the piezoelectric transformer 50. In addition, the advantages of the invention further include a simple structure and a wide dimming range, and the invention can substitute the starter and voltage regulator in the present hot cathode fluorescent lamps without the need for a ballast that will produce very high operating heat. The invention also can achieve the effects of extending the life expectancy of the lamp, reducing the number of components of the lamp, and providing a quick start for the lamp.

While the invention has been described by means of specific embodiments, numerous modifications and variations could be made thereto by those skilled in the art without departing from the scope and spirit of the invention set forth in the claims.

What is claimed is:

1. A method for dimming a hot cathode fluorescent lamp, that changes the outputted voltage and current of a piezoelectric transformer to drive a hot cathode fluorescent lamp and to adjust the brightness of said hot cathode fluorescent lamp, comprising:
generating a pulse width modulation control signal having duty cycles Ton and Toff; and
a high-frequency alternate current signal S2, having different frequencies f1, f2 produced by different duty cycles Ton and Toff of said pulse width modulation control signal, for driving said piezoelectric transformer; so as to adjust the outputted voltage and current of said piezoelectric transformer and adjusting the brightness of said hot cathode fluorescent lamp.

2. The method for dimming a hot cathode fluorescent lamp of claim 1, wherein said pulse width modulation control signal controls a power supply unit by a pulse width modulation technology to output said pulse width modulation control signal.

3. The method for dimming a hot cathode fluorescent lamp of claim 1, further comprising the step of changing a duty ratio of said pulse width modulation control signal to adjust the brightness of said hot cathode fluorescent lamp.

4. The method for dimming a hot cathode fluorescent lamp of claim 1, wherein said high-frequency alternate current signal S2 at different frequencies f1, f2 of duty cycles Ton and Toff provides different voltage gains for said piezoelectric transformer.

5. The method for dimming a hot cathode fluorescent lamp of claim 1, wherein said piezoelectric transformer at the frequency f1 of said duty cycle Ton has a voltage gain greater than a voltage gain of said duty cycle Toff at the frequency f2.

6. The method for dimming a hot cathode fluorescent lamp of claim 1, wherein an apparatus for dimming hot cathode fluorescent lamp to achieve the method, comprising:
a power supply unit, for providing a direct current power supply to drive said hot cathode fluorescent lamp;
a PWM control unit, for outputting a pulse wave signal S1 by a pulse width modulation technology, and controlling said power supply unit by said pulse wave signal S1 to output a pulse width modulation control signal including duty cycles Ton and Toff;
a resonant frequency control unit, for modulating said pulse width modulation control signal to a high-frequency alternate current signal, and said resonant frequency control unit at different duty cycles Ton and Toff separately producing high-frequency alternate current signals S2 having different frequencies f1, f2;
a piezoelectric transformer, for producing a gain for said high-frequency alternate current signal S2 to drive a high output voltage Vout and an output current Iout required by said hot cathode fluorescent lamp, and further to drive said hot cathode fluorescent lamp to shine.

7. The apparatus for dimming hot cathode fluorescent lamp of claim 6, wherein said pulse width modulation control signal has a variable duty ratio, for adjusting the brightness of said hot cathode fluorescent lamp.

8. The apparatus for dimming hot cathode fluorescent lamp of claim 6, wherein said high-frequency alternate current signal S2 at different frequencies f1, f2 of said duty cycles Ton and Toff provides different voltage gains to said piezoelectric transformer.

9. The apparatus for dimming hot cathode fluorescent lamp of claim 8, wherein said piezoelectric transformer at the frequency f1 of said duty cycle Ton has a voltage gain greater than a voltage gain at the frequency f2 of said duty cycle Toff.
